(19) United States
(12) Patent Application Publication
(10) Pub. No.: US 2013/0013543 A1
(43) Pub. Date: Jan. 10, 2013

(54) METHOD FOR THE COMPUTER-AIDED CONTROL OF A TECHNICAL SYSTEM

(76) Inventors: Siegmund Düll, Munchen (DE); Volkmar Sterzing, Neubiberg (DE); Steffen Udluft, Eichenau (DE)

(21) Appl. No.: 13/583,057

(22) PCT Filed: Feb. 15, 2011
(86) PCT No.: PCT/EP2011/052162

§ 371 Date: Sep. 6, 2012

(30) Foreign Application Priority Data
Mar. 12, 2010 (DE) 10 2010 011 221.6

(51) Int. Cl. G06N 3/08

(52) U.S. Cl. 706/25

(57) ABSTRACT

A method for the computer-aided control of a technical system is provided. A recurrent neuronal network is used for modeling the dynamic behaviour of the technical system, the input layer of which contains states of the technical system and actions carried out on the technical system, which are supplied to a recurrent hidden layer. The output layer of the recurrent neuronal network is represented by an evaluation signal which reproduces the dynamics of technical system. The hidden states generated using the recurrent neural network are used to control the technical system on the basis of a learning and/or optimization method.

### CROSS REFERENCE TO RELATED APPLICATIONS

This application is the US National Stage of International Application No. PCT/EP2011/052162, filed Feb. 15, 2011 and claims the benefit thereof. The International application claims the benefits of German application No. 10 2010 011 221.6 DE filed Mar. 12, 2010. All of the applications are incorporated by reference herein in their entirety.

### FIELD OF INVENTION

The invention relates to a method for the computer-aided control and/or regulation of a technical system and a corresponding computer program product.

### BACKGROUND OF INVENTION

Nowadays, technical systems usually have a high degree of complexity, that is, they are described by states having a large number of state variables. In addition, many different actions can be carried out on the technical system based on relevant action variables. The state variables are, in particular, measurable state values of the technical system, for example, physical variables such as pressure, temperature, power and the like. The action variables represent, in particular, adjustable variables of the technical system, for example, the feeding in of fuel to combustion chambers in gas turbines.

For the control of complex technical systems, computer-aided methods are often used which optimize the dynamic temporal behavior of the technical system taking account of pre-determined criteria. Examples of such behavior are learning processes (such as reinforcement learning), as already sufficiently known from the prior art. A variant of a learning process of this type is disclosed in the publication DE 10 2007 001 025 B4. The known methods optimize the dynamic behavior of a technical system by determining suitable actions to be carried out on the technical system, said actions involving changes to particular manipulated variables in the technical system, for example, changes to valve settings, increasing pressures and the like. Each action is evaluated in a suitable manner with an evaluation signal in the form of a reward or a penalty, for example, taking account of a cost function, so that an optimum dynamic behavior can be achieved for the technical system.

In the standard method for controlling or optimizing the dynamic behavior of technical systems as described above, the problem exists that such methods can only be used to a limited extent for technical systems having a large number of state variables and action variables (i.e. in a state space comprising states and actions with a large number of dimensions).

In order to reduce the state variables, it is known from DE 10 2007 001 026 B4 to model a technical system based on a recurrent neural network wherein the number of states in the recurrent hidden layer is smaller than in the input layer or the output layer. The hidden states are used as inputs for the corresponding learning or optimization process for regulating or controlling the technical system. Although the method of said document reduces the number of dimensions in the state space of the hidden layer, the method does not take account of what information content is actually required for modeling the dynamic behavior of the technical system. In particular, for the dynamic behavior modeled there, in the output layer, all the state variables are always predicted from the input layer without analyzing which state variables are actually required for the modeling of the dynamic behavior of the technical system. As a consequence, although the method of said document functions on a reduced state space, it also ensures that in said reduced state space, the dynamic behavior of the technical system is correctly modeled. This leads to greater errors in the modeling or in the computer-aided control and/or regulation of the technical system.

### SUMMARY OF INVENTION

It is an object of the invention to provide a method for controlling and/or regulating a technical system which models the dynamic behavior of a technical system with a high degree of computational efficiency and accuracy.

This aim is achieved through the method according to the claims and the computer program product according to the claims. Further developments of the invention are disclosed in the dependent claims.

The method according to the invention serves for computer-aided control and/or regulation of a technical system which is characterized, for a plurality of time points, in each case by a state with a number of state variables and an action carried out on the technical system with a number of action variables and an evaluation signal for the state and the action.

In the method according to the invention, the dynamic behavior of the technical system is modeled with a recurrent neural network comprising an input layer, a recurrent hidden layer and an output layer based on training data comprising known states, actions and evaluation signals, wherein:

i) the input layer is formed by a first state space with a first dimension which comprises the states of the technical system and the actions performed on the technical system;

ii) the recurrent hidden layer is formed by a second state space with a second dimension and comprises hidden states with a number of hidden state variables;

iii) the output layer is formed by a third state space with a third dimension which is defined such that the states thereof represent the evaluation signals or exclusively those state and/or action variables which influence the evaluation signals.

The dimension of the first state space therefore corresponds to the number of state and action variables in the input layer. The dimension of the second state space is given by the number of hidden state variables. The dimension of the third state space corresponds to the dimension of the evaluation signal (usually one-dimensional) or the number of state and/or action variables which influence said signal.

Following modeling of the dynamic behavior of the technical system, a learning and/or optimization process is performed on the hidden states in the second state space in the method according to the invention for controlling and/or regulating the technical system by carrying out actions on the technical system.

The method according to the invention is distinguished in that a recurrent neural network is used, the output layer of which is influenced by the evaluation signal or exclusively by variables determining the evaluation signal. In this way, it is ensured that only variables which actually influence the dynamic behavior of the technical system are modeled in the recurrent neural network. By this means, even on a reduction of the second dimension of the second state space, the dynamic behavior of the technical system can be very well modeled. Therefore a very precise and computationally efficient regulation and/or control of the technical system is made possible based on the hidden states in the hidden layer.

Preferably, in the method according to the invention, the modeling of the dynamic behavior of the technical system takes place such that the recurrent neural network is trained using the training data such that the states of the output layer are predicted for one or more future time points from one or more past time points. This is achieved in that, for example, the errors between the predicted states and the states according to the training data are minimized. Preferably, during the prediction, the expected value of the states of the output layer and, particularly preferably, the expected value of the evaluation signal are predicted.

In order to achieve a suitable prediction with the recurrent neural network of the invention, in a preferred variant, the hidden states are linked in the hidden layer via weights such that the weights for future time points differ from the weights for past time points. This means that, in the recurrent neural network, it is permitted for the weights for future time points to be selected differently than for past time points. The weights can be matrices, but can also possibly be represented by neural networks in the form of multi-layer perceptrons. The weights between the individual layers in the neural network can also be realized by matrices or possibly by multi-layer perceptrons.

The method according to the invention has the advantage, in particular, that technical systems with non-linear dynamic behavior can also be controlled and/or regulated. Furthermore, in the method according to the invention, a recurrent neural network with a non-linear activation function can be used.

Any of the processes known from the prior art can be used as the learning and/or optimization process that is applied to the hidden states of the recurrent hidden layer of the recurrent neural network. For example, the method described in the above-mentioned document DE 10 2007 001 025 B4 can be applied. In general, an automated learning process and, in particular, a reinforcement leaning process can be applied for the learning or optimization process. Examples of such learning processes are dynamic programming and/or prioritized sweeping and/or Q-learning.

In order suitably to adjust the second dimension of the second state space in the recurrent neural network, in a further preferred variant of the method according to the invention, the second dimension of the second state space is varied until a second dimension is found which fulfils one or more pre-determined criteria. Said found second dimension is then used for the second state space of the recurrent hidden layer. In a preferred variant, the second dimension of the second state space is reduced step by step for as long as the deviation between the states of the output layer, determined with the recurrent neural network, and the known states according to the training data, is smaller than a pre-determined threshold value. By this means, a second state space with a reduced dimension which enables good modeling of the dynamic behavior of the technical system can be found in suitable manner.

In a further variant of the method according to the invention, the evaluation signal is represented by an evaluation function which depends on part of the state variables and/or action variables. This part of the state and/or action variables can thus possibly form the states of the output layer.

In a particularly preferred embodiment of the method according to the invention, the evaluation signal used in the recurrent neural network is also utilized in the learning and/or optimization process subsequent thereto in order to carry out the actions with respect to an optimum evaluation signal. Optimum in this context indicates that the action leads to a high level of reward and/or lower costs according to the evaluation signal.

The method according to the invention can be utilized in any technical systems for the control or regulation thereof. In a particularly preferred variant, the method according to the invention is used for controlling a turbine, in particular a gas turbine or a wind turbine. For a gas turbine, the evaluation signal is, for example, determined at least by the efficiency and/or pollutant emissions of the turbine and/or the mechanical loading on the combustion chambers. The aim of the optimization is a high efficiency level or low pollutant emissions or a low mechanical loading on the combustion chambers. In the use of the method for regulating or controlling a wind turbine, the evaluation signal can, for example, represent at least the (dynamic) force loading on one or more rotor blades of the wind turbine and the electrical power generated.

Apart from the method described above, the invention also comprises a computer program product having a program code stored on a machine-readable carrier for carrying out the method according to the invention when the program runs on a computer.

### BRIEF DESCRIPTION OF THE DRAWINGS

Exemplary embodiments of the invention will now be described making reference to the attached figures, in which:

FIG. 1 is a schematic representation, illustrating, in general, the modeling of the dynamic behavior of a technical system;

FIG. 2 is a schematic representation of a recurrent neural network which, in one embodiment of the invention, is used for calculating hidden states;

FIG. 3 is a schematic representation of a technical system in the form of a wind turbine wherein, based on data from said system, an embodiment of the method according to the invention was tested;

FIG. 4 is a graph illustrating the results from an embodiment of the method according to the invention based on data from the wind turbine as per FIG. 3; and

FIG. 5 is a graph illustrating the results from an embodiment of the method according to the invention based on the per se known cart-and-pole problem.

### DETAILED DESCRIPTION OF INVENTION

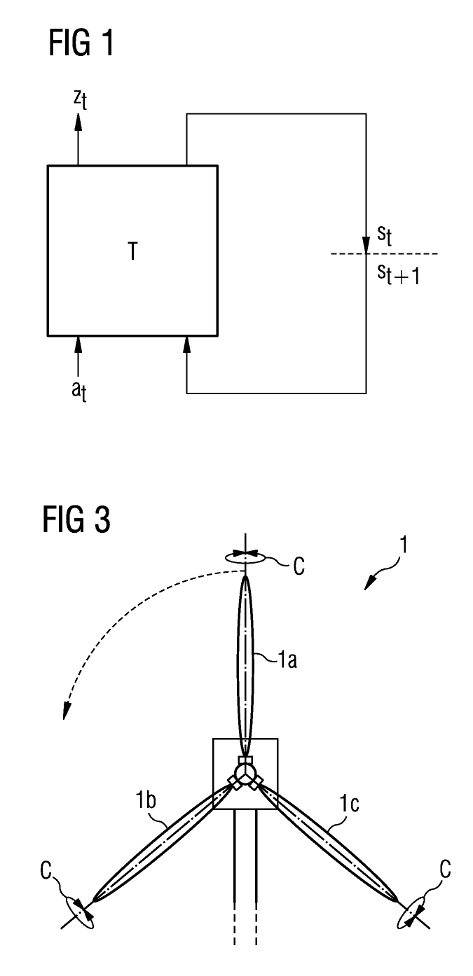

FIG. 1 shows, in schematic form, the dynamic behavior of a technical system observed in the invention, indicated by a box with the reference sign T. The technical system is described at a time point t by an observable state or an “observable” zₜ and an action aₜ performed on the technical system. The system contains internal or hidden states sₜ which are not observable. The hidden state sₜ is changed by an action aₜ and is transformed into the state sₜ₊₁. The state sₜ₊₁ depends on the action aₜ and the preceding state sₜ. The technical system T is also specified by a suitable evaluation signal (not shown in FIG. 1) which defines the extent to which the action performed in one state of the technical system is evaluated as good with regard to an optimum operation of the technical system. Examples of such evaluation signals are the pollutant emission of the technical system or the mechanical loading and alternating loading of the technical system in operation, wherein the target of control or regulation of the technical system is low emissions or low mechanical loading.

In the method according to the invention, suitable modeling of the dynamic behavior of the technical system, taking account of the evaluation signal, is initially carried out on the basis of training data comprising states and actions at a large number of time points. In the description below, a reward signal also generally known as a “reward” is considered to be an evaluation signal, and is to be as large as possible during operation of the technical system. It is assumed that the description of the technical system based on the states and actions represents a Markov decision process, wherein for this decision process, only the reward signal represents relevant information. Markov decision processes are known from the prior art and are disclosed in greater detail, for example, in DE 10 2007 001 025 B4.

In the method according to the invention, the relevant information for the Markov decision process defined by the reward is encoded in the hidden state sₜ, wherein—in contrast to known methods—information which is not relevant for the Markov decision process remains unconsidered. In order to achieve this, the recurrent neural network used for modeling the dynamic behavior of the technical system, is configured such that said neural network contains, in the output layer, the reward signal or exclusively variables influencing the reward signal, as described below in greater detail.

As described above, modeling of the dynamic behavior of the technical system is performed such that suitable hidden states of the technical system are obtained. Suitable learning and/or optimization processes can subsequently be used on said states for controlling or regulating the technical system. Then, in actual operation of the technical system, said methods supply the relevant optimum action in a particular state of the technical system, wherein the optimality is specified by the aforementioned reward signal.

For better understanding, it will now be described how, in conventional manner by means of a recurrent neural network, the dynamic behavior of a technical system can be modeled and thereby corresponding hidden states can be obtained. In general, the dynamic behavior of a technical system for sequential time points (t=1, . . . , T, Tε [symbol] ) can be described as follows:

sₜ₊₁=ƒ(sₜ,zₜ,aₜ) (1)

zₜ=g(sₜ) (2)

In conventional methods, a dynamically consistent recurrent neural network is used in order to describe the Markov state space. The aim of this network is to minimize the error in the predicted states zₜ of the technical system in relation to the measured states zₜ^{d}. Mathematically, this can be defined as follows:

$${\sum }_{t = 1}^{T} {( {z}_{t} - {z}_{t}^{d} )}^{2} \to {min}_{f , g} \qquad ( 3 )$$

Therefore, suitable parameterizing of the functions f and g

is sought such that the deviation between the predicted and actually observed states is minimal. Documents DE 10 2007 001 025 B4 and DE 10 2007 001 026 B4 disclose this type of modeling of the technical system based on recurrent neural networks. As mentioned above, the output layers in said networks contain the observables which are to be predicted.

The observables are generally described by a vector zₜ made up of a plurality of state variables. Similarly, the actions are described by a vector aₜ with a plurality of action variables. It has been recognized that, in many cases, not all entries of the vectors zₜ or aₜ have to be taken into account to model the dynamic behavior of the technical system. This is achieved with the Markov decision process extraction network described below and referred to hereinafter as the MPEN network. Some changes are made thereto in relation to a conventional, dynamically consistent recurrent neural network.

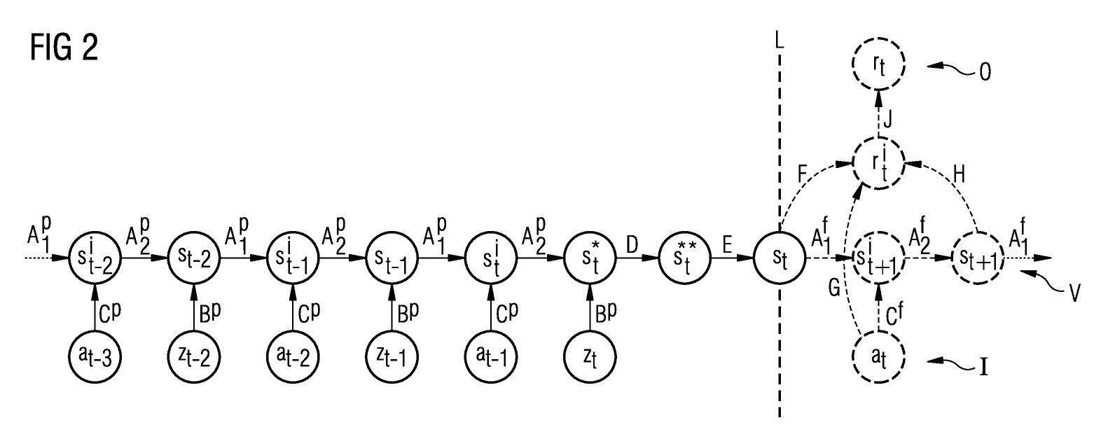

A special embodiment of an MPEN network is shown in FIG. 2. The input layer of the MPEN network in the figure is identified as I, the hidden layer is identified as V and the output layer as O. The current time point is the time point t. It is evident that the input layer comprises the states zₜ₋₂, zₜ₋₁, zₜ and the corresponding actions aₜ₋₃, aₜ₋₂, aₜ₋₁ which flow in suitable manner into the corresponding hidden states in the hidden layer V. In the embodiment of FIG. 2, two types of hidden state exist for the past, specifically sₜ₋₂ⁱ, sₜ₋₁ⁱ and sₜ₋₂, sₜ₋₁. Furthermore, at the current time point t, the network contains the hidden states sₜ* and sₜ**. Linked to one state and to one action performed in this state is the aforementioned reward and one action performed in said state, said reward being identified for the time point t in FIG. 1 as rₜ. In FIG. 2, a reward to be predicted for the output layer at the current time point t is shown. As a rule, the output layer contains further rewards rₜ₊₁, rₜ₊₂, etc., lying in the future which are predicted by the network.

The dashed portion of the network in FIG. 2 illustrates the prediction of the reward rₜ at the time point t, which is linked to an internal reward rₜⁱ. In contrast to known networks, the output layer O is now described by reward signals and not by state vectors. This makes it necessary to divide the network of FIG. 2 into two parts, the first partial network lying on the left-hand side of the line L in FIG. 2 and relating to the past and present, and the second partial network lying on the right-hand side of the line L and using information from the first partial network for predicting rewards. It should be noted that the aim of the network in FIG. 2 is not the prediction of a sequence of actions, i.e. the action aₜ shown and further future actions (not shown) are pre-determined. Only the rewards based on the pre-determined actions are predicted. The individual states in the layers are linked to one another in a suitable manner via weight matrices identified with capital letters, the dynamic behavior of the network in FIG. 2 being described by the following equations:

sₜ₋₁=ƒ(A₂^{p}·sₜ₋₁ⁱ+B^{p}·zₜ₋₁−θₛ^{p}) (4)

sₜⁱ=ƒ(A₁^{p}·sₜ₋₁ⁱ+C^{p}·aₜ₋₁−θ^{ip}) (5)

sₜ*=ƒ(A₂^{p}·sₜⁱ+B^{p}·zₜ−θₛ) (6)

s**=ƒ(D·sₜ*−θ**) (7)

sₜ=ƒ(E·sₜ**−θ_{E}) (8)

sₜ₊₁ⁱ=ƒ(A₁^{f}·sₜ₋₁+C^{f}·aₜ₋₁−θ^{if}) (9)

sₜ₊₁=ƒ(F·sₜ+G·aₜ+H·sₜ₊₁−θᵣⁱ) (10)

rₜⁱ=ƒ(F·sₜ+G·aₜ+H·sₜ₊₁−θᵣⁱ) (11)

rₜ=ƒ(J·rₜⁱ−θᵣ) (12)

the symbols printed bold being real-value vectors, all the capital letters representing real-value matrices, all θ representing real-value, scalar threshold values and ƒ(•):IR ^{J̅}→IR ^{J̅} representing an arbitrary, usually sigmoid activation function.

In place of the use of weight matrices, multi-layer perceptrons may possibly be used to describe the weightings.

A further aspect of the network of FIG. 2 lies therein that, for the past, other weight matrices (specifically A₁^{p}, A₂^{p}) as well as for the future (specifically A₁^{f}, A₂^{f}) are used. This is achieved by the above described division into a first and a second partial network. In general, this division into partial networks can be described such that a partial network is formed for past states and a partial network is formed for future states such that, for the predicting hidden state, the following condition applies:

$${s}_{t + 1} = \{ \begin{matrix}{f}_{past} ( {s}_{t} , {z}_{t} , {a}_{t} ) , t < 0 \\ {f}_{present} ( {s}^{*} , {a}_{t} ) , t = 0 \\ {f}_{future} ( {s}_{t} , {a}_{t} ) , t > 0\end{matrix} \qquad ( 13 )$$

By means of the corresponding functions ƒₚₐₛₜ, ƒₚᵣₑₛₑₙₜ and ƒ_{future}, in general, the corresponding couplings reproduced in FIG. 2 via matrices are described. According to the invention, in place of all the observed state variables, the reward signal is used as a target variable. This means that the following state variable is predicted:

rₜ=g(sₜ,aₜ), t≧0 (14)

It should be noted that the current hidden state sₜ and the action aₜ carried out are sufficient to describe the expected value of all the relevant reward functions, since all information concerning the subsequent state sₜ₊₁ must be contained within these arguments. With the reward signal as a target variable, the optimization performed by the MPEN network can be described as follows:

$${\sum }_{t = 1}^{T} {( {r}_{t} - {r}_{t}^{d} )}^{2} \to {min}_{f , g} \qquad ( 15 )$$

It is clear that, in contrast to equation (3), based on known reward signals rₜ^{d} from training data, parameterization for f, g which minimizes the error between the predicted reward signal and the known reward signal is sought. A recurrent neural network of this type accumulates all the information that is required for the Markov property from a sequence of past observations in the first partial network, whereas the second partial network optimizes the state transitions.

The MPEN network described above is based on the well-established concept that a recurrent neural network can be used to approximate a Markov decision process in that all the expected future consequential states are predicted based on a history of observations. Due to the recurrent neural network structure, each state must encode all the required information in order to predict a subsequent state resulting from the performance of an action. For this reason, a recurrent neural network must be capable of estimating the expected reward signals for each future state, since a reward function can only use one state, one action and one subsequent state as the arguments. From this it follows that, for reinforcement learning with a recurrent neural network, it is sufficient to model a dynamic behavior that is capable of predicting the reward signal for all future time points. The MPEN network described above and shown by way of example in FIG. 2 was constructed on the basis of this statement.

A suitable MPEN network learned with training data is used within the context of the invention as a state estimator for the hidden state sₜ₊₁. This state then serves as the input for a further learning and/or optimization process. In this aspect, the method according to the invention corresponds to the method described in document DE 10 200 001 026 B4, wherein, however, according to the invention, a different modeling of the dynamic behavior of the technical system is used. For the downstream learning and/or optimization process, automated learning processes known from the prior art are used and, for example, the reinforcement learning process disclosed in DE 10 2007 001 025 B4 can be used. Similarly, the known learning processes of Dynamic Programming, Prioritized Sweeping and Q-Learning can be used.

FIG. 3 illustrates a technical system in the form of a wind turbine with which, based on operating data of the wind turbine, an embodiment of the method according to the invention was tested. The wind turbine is identified in FIG. 1 with the reference sign 1 and comprises three rotor blades 1a, 1b and 1c. The dynamic behavior of the wind turbine was modeled both with a conventional recurrent neural network and with the MPEN network according to the invention, the load acting on the rotor blades, which is to be minimized being used as the reward signal. An action to be performed on the wind turbine is specified by the change in the angle of attack of an individual rotor blade, this change being indicated by corresponding circles C in FIG. 3.

In the experiments performed, a total of 46 variables were observed as input variables, that is, as states of the input layer. In the conventional recurrent neural network, the output layer was also described using said 46 variables. In the MPEN network according to the invention, by contrast, only the reward signal was regarded as being output to be predicted. Different recurrent neural networks with different numbers of past states and future states or rewards to be predicted were observed. The dimension of the corresponding hidden states (i.e. the number of state variables of a hidden state) was differently selected.

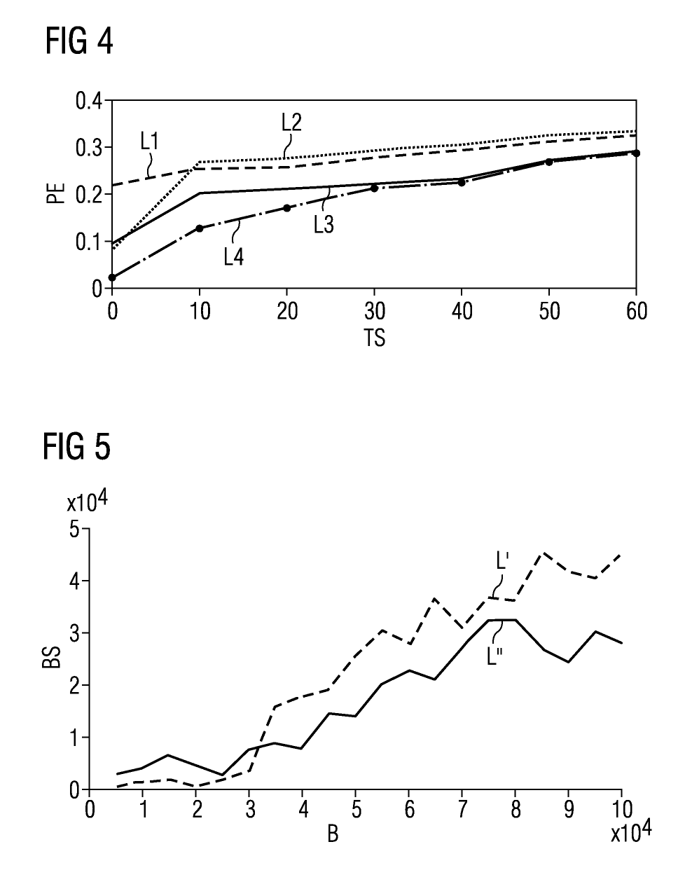

FIG. 4 shows a graph representing the mean prediction error PE for the load on the rotor blades depending on the predicted time step TS in the future. The lines L1 and L2 show the errors for conventional neural networks wherein hidden states with 20 state variables are observed. For the network represented by the line L2, only 26 variables are used in the input layer, in place of 46 variables. By contrast therewith, the line L3 shows an MPEN network with hidden states made up from four state variables and the line L4 shows an MPEN network with hidden states having 20 state variables. It is apparent that the MPEN networks provide better predictions than the conventional recurrent neural networks, although said networks use a hidden state space with only four variables. The MPEN network according to the invention, for which reward signals are predicted, therefore describes very well the dynamic behavior of a technical system in the form of a wind turbine. The method is highly computationally efficient, since a low number of hidden state variables for modeling the system is sufficient. It can thus be assumed that subsequent control or regulation of a wind turbine based on hidden states predicted with the MPEN network enables optimized operation of the wind turbine with the smallest possible load on the rotor blades.

The method according to the invention was also tested using the cart-and-pole problem which is sufficiently well known from the prior art. This problem is described in greater detail, for example, in the document DE 10 2007 001 025 B4. The classic cart-and-pole problem concerns a rod which is pivotably fixed to a vehicle which moves in a plane, the vehicle being able to move back and forth between two limits. The rod is oriented upwardly and the aim is to balance the rod for as long as possible by displacing the vehicle within the limits without reaching the limits or the rod inclining more than 12° to the vertical. The problem is solved when the rod is balanced for more than 100,000 steps, each of which represents a pre-defined movement of the vehicle. A suitable reward signal is represented by the value −1 when one of the limits is reached. Otherwise the reward signal is 0. The Markovian state of the cart-and-pole problem at any time point t is fully described by the position of the vehicle xₜ, the speed of the vehicle \dot{x}ₜ, the angle of the rod perpendicular to the vehicle αₜ and the angular velocity \dot{α}ₜ of the rod. Possible actions include a movement of the vehicle to the left or to the right with a constant force F or no application of a force.

For the test of the method according to the invention, only three observables, specifically the position and the speed of the vehicle and the angle of the rod, were observed in the input layer of the MPEN network. The Markov condition was therefore infringed. The hidden states obtained with the MPEN network were subsequently fed to a learning process based on table-based dynamic programming. Although the Markov condition is infringed by the observation of only three observables, nevertheless, a Markov decision process was able to be extrapolated in a suitable manner with the MPEN network and the cart-and-pole problem satisfactorily solved.

This is illustrated in FIG. 5, which is a graph reproducing the learned action selection rules. The line L′ in FIG. 5 represents the number of sequential balancing steps BS obtained with the MPEN network and the subsequent dynamic programming, as a function of the number of observations B with which the dynamic programming was learned. The line L″ in FIG. 5, by contrast, represents the number of sequential balancing steps for dynamic programming based on the original four observables without an upstream MPEN network. The MPEN network was trained with 25,000 training data, with—as mentioned above—only three observables being taken into account. It is evident from FIG. 5 that, despite the omission of an observable for the cart-and-pole problem, very good results are obtained with a large number of balanced steps.

As the foregoing description shows, the method according to the invention has a series of advantages. In particular, a high level of prediction quality is achieved, which is substantially better than in conventional recurrent neural networks. Furthermore, when modeling the dynamic behavior of the technical system, a compact internal state space with few hidden state variables is used. This opens up the possibility for the learning and/or optimization processes applied to the hidden states of also using methods which require a state space having a small dimension as the input data.

In the method according to the method, through the use of the evaluation signal and/or the variables exclusively influencing the evaluation signal as the target values to be predicted, only the aspects that are relevant to the dynamic behavior of the system are taken into account. By this means, a state with a minimum dimension which is subsequently used as a state for a corresponding learning process or a model-predictive regulation or other optimization process, can be used in the hidden layer to search in the space of actions and in order thereby to solve an optimum control problem based on the evaluation signal.

1-15. (canceled)

16. A method for computer-aided control and/or regulation of a technical system, wherein:
providing the technical system, which for a plurality of time points, includes for each time point, a state with a number of state variables and an action carried out on the technical system with a number of action variables and an evaluation signal for the state and the action;
modeling the dynamic behavior of the technical system with a recurrent neural network comprising an input layer, a recurrent hidden layer and an output layer based on training data comprising known states, actions, and evaluation signals, wherein:
the input layer is formed by a first state space with a first dimension which comprises the states of the technical system and actions performed on the technical system,
the recurrent hidden layer is formed by a second state space with a second dimension and comprises a plurality of hidden states with a plurality of hidden state variables,
the output layer is formed by a third state space with a third dimension which is defined such that the states thereof represent the evaluation signals or exclusively those state and/or action variables which influence the evaluation signals; and
performing a learning and/or optimization process on the plurality of hidden states in the second state space for controlling and/or regulating the technical system by carrying out actions on the technical system.

17. The method as claimed in claim 16, wherein in the modeling of the dynamic behavior of the technical system, the recurrent neural network is trained using the training data such that the states of the output layer are predicted for a future time point from a past time point.

18. The method as claimed in claim 17, the plurality of hidden states are linked in the hidden layer via a plurality of weights such that a first plurality of weights for a plurality of future time points differ from a second plurality of weights for a plurality of past time points.

19. The method as claimed in claim 16, wherein the technical system includes a non-linear dynamic behavior.

20. The method as claimed in claim 16, wherein in the modeling, the recurrent neural network uses a non-linear activation function.

21. The method as claimed in claim 16, the learning and/or optimization process is an automated learning process.

22. The method as claimed in claim 21, wherein the learning and/or optimization process is a reinforcement learning process.

23. The method as claimed in claim 22, wherein the learning and/or optimization process includes programming, prioritized sweeping and Q-learning.

24. The method as claimed in claim 22, wherein the learning and/or optimization process includes programming or prioritized sweeping or Q-learning.

25. The method as claimed in claim 16, wherein in the modeling, the second dimension of the second state space is varied until a second dimension is found which fulfils a pre-determined criteria.

26. The method as claimed in claim 25, wherein in the modeling, the second dimension of the second state space is reduced step by step for as long as the deviation between the states of the output layer, determined with the recurrent neural network, and the known states according to the training data, is smaller than a pre-determined threshold value.

27. The method as claimed in claim 16, wherein the evaluation signal is represented by an evaluation function which partially depends on the state variables and/or action variables.

28. The method as claimed in claim 16, wherein the learning and/or optimization process uses the evaluation signals in order to carry out the actions with respect to an optimum evaluation signal.

29. The method as claimed in claim 16, wherein the technical system is a turbine.

30. The method as claimed in claim 29, wherein the turbine is a gas turbine or a wind turbine.

31. The method as claimed in claim 30,
wherein the technical system is a gas turbine, and
wherein the evaluation signal is determined at least by the efficiency, pollutant emissions of the gas turbine, the alternating pressures, and the mechanical loading on the combustion chambers of the gas turbine.

32. The method as claimed in claim 30,
wherein the technical system is a gas turbine, and
wherein the evaluation signal is determined at least by the efficiency or pollutant emissions of the gas turbine or the alternating pressures or the mechanical loading on the combustion chambers of the gas turbine.

33. The method as claimed in claim 30,
wherein the technical system is a wind turbine, and
wherein the evaluation signal is determined at least by the force loading and alternating loading on a rotor blade of the wind turbine.

34. The method as claimed in claim 30,
wherein the technical system is a wind turbine, and
wherein the evaluation signal is determined at least by the force loading or alternating loading on a rotor blade of the wind turbine.

35. A computer program product having a program code stored on a machine-readable carrier for carrying out the method as claimed in claim 16, when the program runs on a computer.
